(19) United States
(12) Patent Application Publication
(10) Pub. No.: US 2016/0225070 A1
(43) Pub. Date: Aug. 4, 2016

(54) METHOD AND SYSTEM FOR CONDUCTING A SILENT AUCTION

(71) Applicant: BTM Investments LLC, Indianapolis, IN (US)

(72) Inventors: Joseph A. Pence, Carmel, IN (US); Brad A. Benge, Indianapolis, IN (US); Spencer M. Zimmerman, Carmel, IN (US)

(21) Appl. No.: 15/000,147

(22) Filed: Jan. 19, 2016

Related U.S. Application Data
(63) Continuation of application No. 13/409,465, filed on Mar. 1, 2012, now abandoned.
(60) Provisional application No. 61/449,342, filed on Mar. 4, 2011.

(51) Int. Cl. G06Q 30/08; H04M 1/725; H04W 4/14

(52) U.S. Cl. CPC G06Q 30/08; H04W 4/14; H04M 1/72552

(57) ABSTRACT

A method for conducting a silent auction using software that communicates via text/SMS messaging with a bidder's personal mobile phone devices using the bidder's wireless service provider. The auction management software may be effective for managing and conducting multiple auctions simultaneously.

### REFERENCE TO RELATED APPLICATIONS

This application is a continuation application of U.S. patent application Ser. No. 13/409,465, filed Mar. 1, 2012, which claims the benefit of U.S. Provisional Patent Application Ser. No. 61/449,342, filed Mar. 4, 2011, both of which are hereby incorporated herein by reference.

### BACKGROUND

An auction is a process of buying and selling goods or services by offering them up for bid, taking bids, and then selling the item to the highest bidder. The most common form of auction is generally referred to as the “live” auction, in which participants bid openly against one another, with each subsequent bid being higher than the previous bid. “Silent” auctions differ from “live” actions in that there is no auctioneer selling individual items. Instead, the items to be auctioned are typically made available to auction bidders by displaying the items on tables at an auction site. A sheet of paper is typically provided with each item, and bidders circulate through the auction site and view the items. If a bidder desires to bid on an item, the bidder writes his bid on the sheet of paper accompanying the item after observing any minimum or pending bid displayed on the paper. At the end of the auction, the highest listed bidder wins the item. This auction is often used in charity events, with many items auctioned simultaneously and “closed” at a common finish time.

A recent development in silent auctions has been to provide auction attendees with a handheld device pre-loaded with auction items, including item description, value, bid increments, photo, and donor information. The provided handheld device communicates with a central auction management system over a local wireless network. Guests are free to browse the auction items in person or electronically, but they use the provided handheld device and local wireless network to bid during the event.

A need exists for improvements to known silent auction technologies. The present invention addresses that need.

### SUMMARY OF THE INVENTION

Briefly describing one aspect of the present invention, there is provided a method for conducting a silent auction. In one aspect of the invention the method comprises:
a) providing auction management software effective for managing multiple auctions simultaneously, wherein said auction management software is adapted to communicate with bidders using text (preferably SMS) messaging from the bidder's existing mobile phone handset with the bidder's existing mobile phone service provider;
b) setting up an auction for an auctioning individual or organization by populating said auction management software with information relating to items to be auctioned;
c) registering potential bidders to participate in the auction, wherein said registering includes associating the potential bidder's personal mobile phone device with a specific auction event;
d) allowing registered bidders to bid on items available at the auction by communicating a unique item identification and bid amount to the auction management software by sending a text message from the bidder's existing mobile phone handset using the bidders existing mobile phone service provider;
e) having the auction management software communicate back to the bidders to inform the bidders of the status of the bid;
f) closing the auction by ceasing to allow new bids, identifying the high bidder for items receiving bids, and notifying winners of their successful bids.

In another embodiment the auction management software is effective for organizing and conducting multiple, separate auctions simultaneously by maintaining for each auction records relating to auction items; wherein said auction records include one or more of:
a) item descriptions;
b) unique item identifications;
c) starting bids;
d) bidding increments;
e) auction start time; and
f) auction end time.

In another embodiment the “setting up” step comprises populating said auction management software with one or more of:
a) item descriptions;
b) unique item identifications;
c) starting bids;
d) bidding increments;
e) auction start time; and
f) auction end time.

In another embodiment the method further comprises allowing the bidder to take action subsequent to bidding, wherein said subsequent action comprises entering a second bid on an item for which the bidder is not the high bidder.

A further embodiment of the present invention provides a system for conducting a silent auction. The system comprises auction management software effective for managing multiple auctions simultaneously, wherein the auction management software is adapted to receive bids in the form of text messages from bidders' existing mobile phone handsets using the bidders' existing mobile phone service providers.

### BRIEF DESCRIPTION OF THE DRAWINGS

FIG. 1 is a flow diagram showing certain aspects of the present invention according to one embodiment.

FIGS. 2A and 2B are a flow diagram showing certain aspects of the present invention according to one embodiment, with FIG. 2B being a continuation of the process shown in FIG. 2A.

FIG. 3 is a flow diagram showing certain aspects of the present invention according to one embodiment.

FIGS. 4A, 4B and 4C are a flow diagram showing certain aspects of the present invention according to one embodiment, with FIG. 4B being a continuation of the process shown in FIG. 4A, and with FIG. 4C being a continuation of the process shown in FIG. 4B.

FIGS. 5A, 5B and 5C are a flow diagram showing certain aspects of the present invention according to one embodiment, with FIG. 5B being a continuation of the process shown in FIG. 5A, and with FIG. 5C being a continuation of the process shown in FIG. 5B.

FIG. 6 is a flow diagram showing certain aspects of the present invention according to one embodiment.

FIGS. 7A and 7B are a flow diagram showing certain aspects of the present invention according to one embodiment, with FIG. 7B being a continuation of the process shown in FIG. 7A.

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

As indicated above, one aspect of the present invention relates to a method and system for conducting a silent auction. In one embodiment of the inventive method, bidders register their personal mobile phone device to be the device that communicates with the auction management system at an auction event. Each bidder may then bid on auction items by sending text (SMS) messages from their mobile phone device using the bidder's wireless phone service provider. The auction management system software receives text/SMS messages from bidders, decodes each text/SMS message to determine who the bidder is and what information the bidder is trying to communicate, and takes the appropriate action based on the indicated bidder intent. The auction management system may be capable of managing two or more auction events simultaneously.

In this disclosure three primary entities participate. They are identified as: 1) the auction organizer, which is the person or entity who desires to conduct the auction and who will (at least initially) receive the money paid for items at the auction; 2) the auction management system provider (alternatively referred to as the auction system provider), which is the entity that provides and maintains the hardware and software used to register bidders and conduct the auction for the auction organizer; and 3) the bidders, who are the entities who bid on items being auctioned.

Creating/Setting-Up and Editing an Auction

To create a new auction, a person or group desiring to hold an auction (the auction organizer) will work with an auction management system provider to set up the event. The auction management system provider typically provides the software and services necessary for conducting the auction. The auction management system provider may also provide hardware, including computer hardware for running the auction software, and may additionally provide access to other hardware and software such as telephone text or voice messaging and/or internet service.

The auction management system provider may provide the auction organizer with a unique username and password to allow the auction organizer to access the auction website. The auction system provider also may provide the auction organizer with an event code that identifies the auction event and distinguishes it from other events using the auction management system provider's software. In some embodiments the auction management system provider provides software that can manage and conduct multiple auctions simultaneously.

Once an event code has been determined, the auction organizer may enter information for items to be sold at the auction. Included among the information is an item identifier, which may be an identification number. In one preferred embodiment the identification number includes a portion which identifies the auction event, and a portion which identifies the item being auctioned at the event. In one preferred embodiment the identification number is a six- or seven-digit item number, with the first three digits identifying the auction event and the remaining three or four digits identifying the item to be auctioned. In other embodiments the item number may include a “group” number which identifies an item as being a member of a specific group of items.

The auction organizer may also enter additional data for specific items being auctioned at the event. For example, item descriptions (which may include a “short” description of less than about 15 characters, and/or a “long” description of up to about 100 characters), starting bid, reserve value, retail (or fair market) value, shipping information, and bidding increments (including minimum and/or maximum bid increments) may be entered for some or all items.

The auction organizer may also set other parameters that apply to all items being auctioned at the event, such as the starting date and/or time, the ending date and/or time, and bidding increments that may apply generally to all items if other bidding increments are not provided.

An ending date or time may be established, or the auction organizer can end the auction at any time, such as when a specific goal (which may be a specific number of items sold, or a specific amount of money raised) has been attained or when an event being held in conjunction with the auction ends. In other embodiments an auction may be ended for one or more specific items or groups of items without ending the auction for other items or groups of items.

In some embodiments of the present invention the auction organizer has the ability to edit any or all of the information and parameters that have been entered into the system. The system may be limited to prevent editing of some or all information or parameters after bidding has begun.

The Bidder Registration Process

Either before or after item information has been entered into the system, the auction organizer and/or the system provider may register bidders for the auction. The system may be used with either a “closed registration” auction or an “open registration” auction. As used herein, a closed registration auction is an auction where the set of potential bidders is limited to people who satisfy some pre-determined criterion, such as people who are members of a particular organization, people who have been invited by the auction organizer, etc. Thus, in a closed auction the set of potential bidders may be known to and/or identified by the auction organizer.

In contrast, an open registration auction is an auction where the set of potential bidders is generally anyone who may choose to bid. However, even in an “open” auction the set of potential bidders may be limited to people of a minimum age (e.g., people at least 18 years old), and/or people with a recognized ability to pay (e.g. people with a generally-recognized credit card), etc.

Accordingly, it is possible and common in a closed auction for the potential bidders to identified and registered before the event begins. In an open auction however, it is more common for the set of potential bidders to include people who are not identified and/or known to the auction organizer, and who are not registered before the auction begins. In either case though, the bidders may be registered before or when they ready to bid.

In one embodiment, potential bidders (or “customers”) are invited to register for the auction by sending an email or text message to the potential bidder. The message includes and/or link to a specific url to register for the auction. The url web form may require the potential bidder to enter a name and/or address and/or telephone number, which may be a mobile telephone number. Preferably, the mobile telephone number is associated with a text messaging service. This registers the name and number with the auction.

In another embodiment, the potential bidders may register for the auction by providing a name and/or address and/or telephone number (which may be a mobile telephone number) to a registration worker at a registration desk.

In another embodiment, the potential bidders may register for the auction by providing a name and/or address and/or telephone number (which may be a mobile telephone number) by placing a telephone call to a registration worker or an automated Interactive Voice Response system. The telephone call may be placed using a toll-free number such as a toll-free number. The registration worker or automated Interactive Voice Response system may respond by collecting information necessary to process the registration.

In another embodiment, the potential bidders may register for the auction by providing a name and/or address and/or telephone number (which may be a mobile telephone number) via text messaging to a telephone number provided by the auction organizer or system provider. The potential bidder may send a keyword (such as “BID”) to a short code (such as 86132) and then the auction system platform may respond with an inquiry that starts the registration process.

In some preferred embodiments of the present invention, a potential bidder may be identified during the auction registration process by a method described in applicants' U.S. Pat. No. 7,584,147, or in applicants' U.S. patent application Ser. No. 12/551,854, the entire contents of both of which are hereby incorporated herein by reference. This process may be referred to herein as the “Qtego” or “Qtego^{SM}” identification process.

In the most preferred embodiment of the present invention, the registration process includes associating a potential bidder's personal mobile phone device with an auction event.

Regardless of the mechanism by which a potential bidder registers for the auction, the bidding system software (referred to as the “platform”) assigns a customer number to the customer. Each customer number is unique, and identifies the customer as his/her bids are being processed. The customer number is preferably not communicated to the potential bidder.

Conducting the Auction

Once the auction has been set-up and bidders have been registered, bidding may proceed. As with prior art silent auctions, potential bidders may attend the event and view the auction items on which they may bid. Alternatively, the potential bidders may view the auction items online. In both cases, the auction items are preferably identified by an ID number and description, as outlined above.

In one embodiment the bidder bids on an item by entering the item ID and a bid amount into a text message field and sends the text message to a telephone number or short code provided by the auction organizer or the auction system provider. For example, the bidder may send the text message “124101 50” to short code 86132 to bid $50.00 on item number 101 at auction event 124. The text message may or may not include cents in addition to dollars, and the system may be designed to accept bids only in whole dollar amounts, or in amounts that include both dollars and cents.

In some embodiments the bid amount is the amount of a single “standard” bid. In other embodiments, the bid amount may be a “maximum” bid. When a standard bid is received, the system processes the bid according to its amount as described below. When a maximum bid (MaxBid) is received, the system processes the bid according to whether amounts up to and including the maximum amount will win the auction. Whether a bid is a standard bid or a MaxBid may be communicated by the seller by communicating an identifier, such as the character “M” for a MaxBid, with the bid amount. Accordingly, a bidder may communicate “100” to indicate a standard bid of $100, or the bidder may communicate “100M” to communicate a maximum bid of $100.

When a text message bid is received, the system platform checks the incoming phone number to confirm that the bidder is registered to bid at the auction. The system platform may also confirm that the incoming text message corresponds to an active auction event.

If the texting device is not registered, the platform may first check to see if the bidder is eligible to participate in the auction (for example, the platform may check to see if the auction is open or closed), and if the bidder is eligible to participate the platform may request the potential bidder to register the texting device.

If the texting device is registered, or after the texting device has been registered if that has been done in response to the above, the platform retrieves information such as the current high bid, the high bidder customer number, the high bidder cell number, the item bid increment, and the item description from the system data storage. If the amount bid by the bidder is greater than the minimum bid, the bidder's customer number is compared to the customer number of the current high bidder. If the two customer numbers are the same, the customer is notified that he/she is already the high bidder.

If the two customer numbers are different, the platform checks to see if the bid amount is greater than the current high bid by the maximum bid increment confirmation value. If the bid amount is greater than the current high bid by the maximum bid increment confirmation value, it is likely that a data entry error has occurred, and the system sends a message to the bidder requesting that they confirm the bid amount. If the bidder confirms that the bid is correct, the bid is processed.

If the bid amount is greater than the current high bid by an amount that is less than the maximum bid increment confirmation value, the platform checks to see if the item has a MaxBid set. If no MaxBid is set, the customer receives a message indicating that they are now the high bidder.

If a MaxBid has been set, the platform checks to see if the bid amount is greater than the MaxBid. If the bid amount is greater than the previous high bid but less than the MaxBid, the platform sets a new high bid amount for the item and notifies the bidder that they have been outbid for the item by the Max Bidder. If the bid amount is greater than the previous high bid amount and also greater than the MaxBid, the platform notifies the bidder that they are now the high bidder for the item. In that case, the platform also sends a message to the previous high bidder indicating that they have been outbid on the item.

The auction for each item may end when a predetermined time is reached, or when the auction organizer decides to end the auction. In any event, high bidders are then notified and are required to pay for the items they have won.

In another embodiment the bidding may be conducted by telephone. In that embodiment, the bidding process proceeds substantially along the same path as used with text bidding. In the telephone embodiment though, the platform checks to see if the telephone device is registered with the auction rather than checking to see if the text messaging device is registered. The platform also receives and responds through an interactive voice response system rather than through text messaging for the following steps.

The present invention provides benefits over the prior art by allowing a bidder to register for the auction, place bids, and otherwise communicate with the auction organizer and auction software system using a text messaging system of a telephone service provider. Similarly, the present invention allows the auction organizer and auction software system to communicate with bidders using only the text messaging system of a telephone service provider. In the prior art, potential bidders and auction organizers were required to use the internet or a closed (local) service if service beyond traditional paper bidding was desired.

The inventive method and system may also provide an Account Management Control Panel (AMCP) to allow the auction organizer to manage all aspects of the auction event. The Account Management Control Panel may be accessed using the Internet by the Auction Administrator (with a unique username and password) and is segmented into 3 primary functions.

1. Manage My Auction—The “Manage My Auction” portion of the AMCP may provide the ability to:
Create a New Auction
Edit an Existing Auction
Delete Auction with No Bids
End Open Ended Auction
Print Item Description
Advanced Items
Reports

2. Bidder Information—The “Bidder Information” portion of the AMCP may provide the ability to:
Quick Add Verified Bidder
Manually Add Bidder—Minimum Information
Manually Add Bidder—Maximum Information
Manually Submit Bid
Broadcast Message
Send Message to One Bidder

3. Find/Search—The “Find/Search” portion of the AMCP may provide the ability to:
List All Items
Search by Item ID
Search by Group ID
Search All Auction(s) with No Bids
Search Auction(s) with No Bids
Recent Bidding Crawler
Recent Winning Crawler
   Additional features and aspects of the present invention may include:

1. BUYOUT is a feature that an auction organizer can set a specific (“buy-now”) price that will immediately close the auction and award the item to the winning bidder if that price is “bid.” This feature may automatically be applied to items that had no bids throughout the auction and attempted to close with no bids. The system will optionally set the buyout to the minimum starting bid and leave the auction open. The first bidder to bid on the item will cause the system to close bidding on that item and award it to the winning bidder.

2. YES is a feature that gives the auction organizer the ability to ask the registered bidders a question. Questions may be formed so that registered bidders may respond with a YES via SMS. The bidders and their responses may be recorded in the database and shown on the pertinent reports.

3. STATUS is a feature that shows bidders their “status” for certain, elected parameters, such as what items they are bidding on, whether they are currently the high bidder, and any items purchased. A running total may be provided.

4. PAY is a feature that launches a phone call from a secure server to allow bidder to pay via credit card. This is particularly useful when the auction location is a golf course or other outdoor site, or when the event is being held over multiple or widespread areas.

Referring now to the Figures discussed below, these flow charts illustrate the concepts described above, as well as some additional aspects of the present invention. It is to be understood that the flow charts are to be illustrative, and not restrictive of the methods and systems of the present invention.

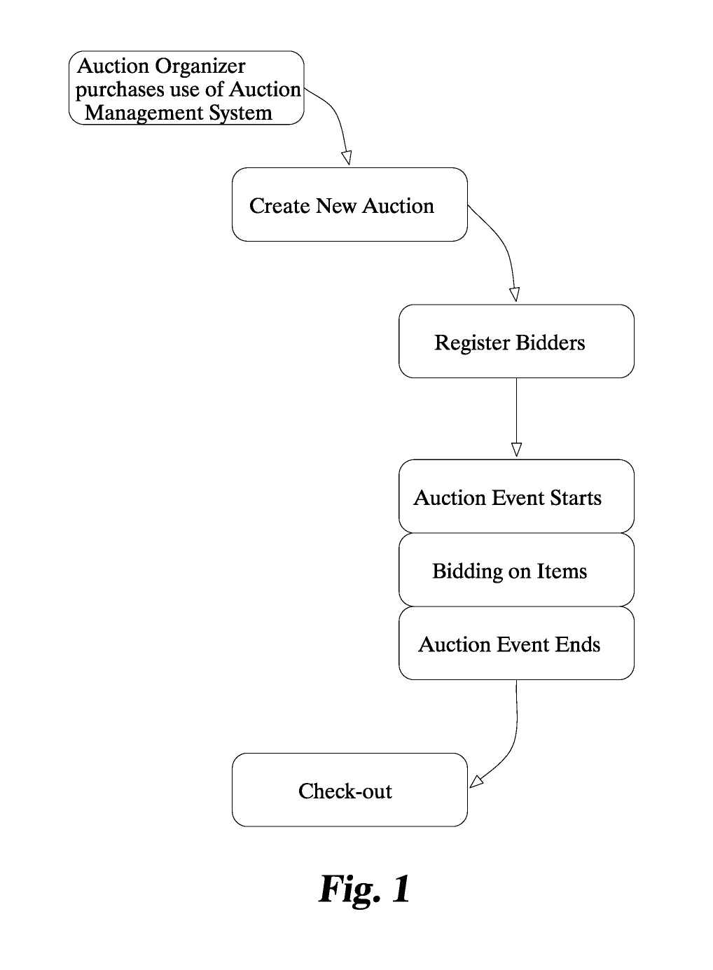

FIG. 1 is a flow chart showing the application of the present invention to an auction conducted using the Qtego^{SM} auction management service. In this method, an auction organizer purchases auction management services from the Qtego^{SM} auction management system provider. The Qtego^{SM} auction management system provider provides the auction management software and uses it to create a new auction. To create the auction the auction organizer and/or the auction management system provider enters data relating to the items to be auctioned and/or the auction parameters. Once the new auction has been created, bidders may be registered for the auction. After the auction event starts, bidders may bid on the items being auctioned. When the auction event ends, winning bidders are identified and notified and the check-out process begins.

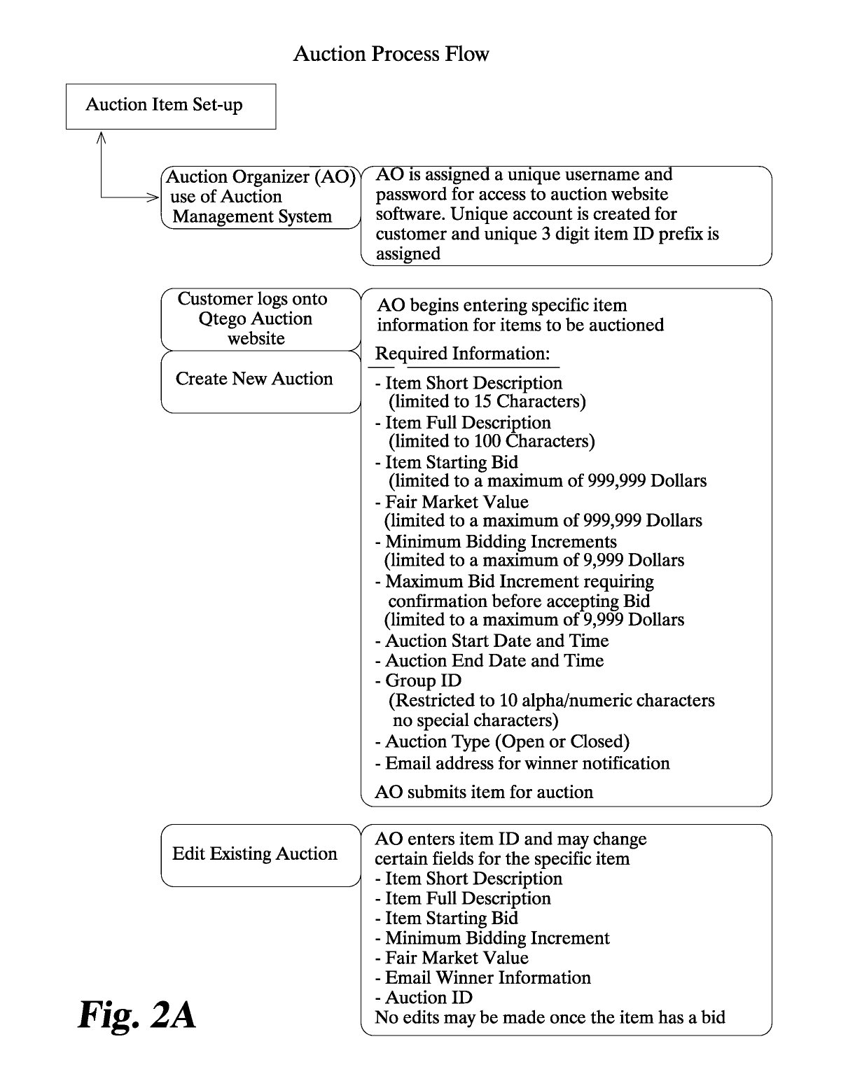

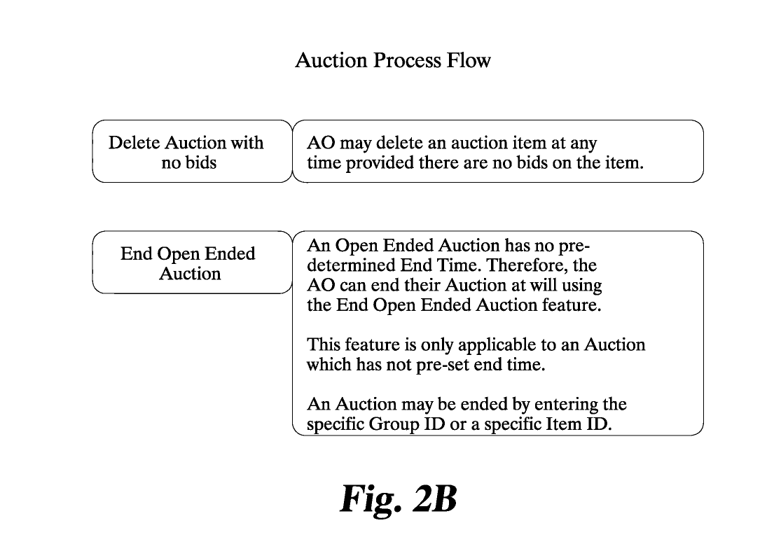

FIGS. 2A and 2B show more detail about the preferred auction set-up process. The illustrated process begins when the auction organizer (customer) purchases the use of auction management system software, such as the Qtego^{SM} Auction Services indicated in the illustrated embodiment. The auction organizer is assigned a unique username and password to allow him/her to access the auction website software. A unique account is created for each auction organizer/customer, and a unique item ID prefix may be assigned.

The auction organizer/customer may then log onto the auction management system website and create a new auction. Once the auction has been created, the auction organizer/customer may begin entering specific item information for the items to be auctioned. Typically the information would include one or more of the following:
Item Short Description (may be limited to about 15 Characters)
Item Full Description (may be limited to about 100 Characters)
Item Starting Bid (may be limited to a maximum value)
Fair Market Value (may be limited to a maximum value)
Minimum Bidding Increments (may be limited to a maximum value)
Maximum Bid Increment requiring confirmation before accepting Bid (may be limited to a maximum value)
Auction Start Date
Auction Start Time
Auction End Date
Auction End Time
Group ID (may be limited to about 10 alpha/numeric characters, with no special characters)
Auction Type (Open or Closed)
Email or text message address for winner notification.

After the item information has been entered, the auction organizer/customer submits the items for the auction.

If necessary, the auction organizer/customer may edit an existing auction. To edit an auction, after the auction organizer/customer enters an item ID he/she may change certain fields for the specific item. For example, the customer may change:
Item Short Description
Item Full Description
Item Starting Bid
Minimum Bidding Increment
Fair Market Value
Email or text message address for Winner Information
Auction ID

It some embodiments of the present invention an AO may delete an auction item at any time provided there are no bids on the item.

For an auction that has no predetermined end time, the AO may end the Auction at will using an “End Open Ended Auction” feature. To use this feature the auction organizer/customer enters the specific Group ID or a specific Item ID and ends the auction on one item or all items.

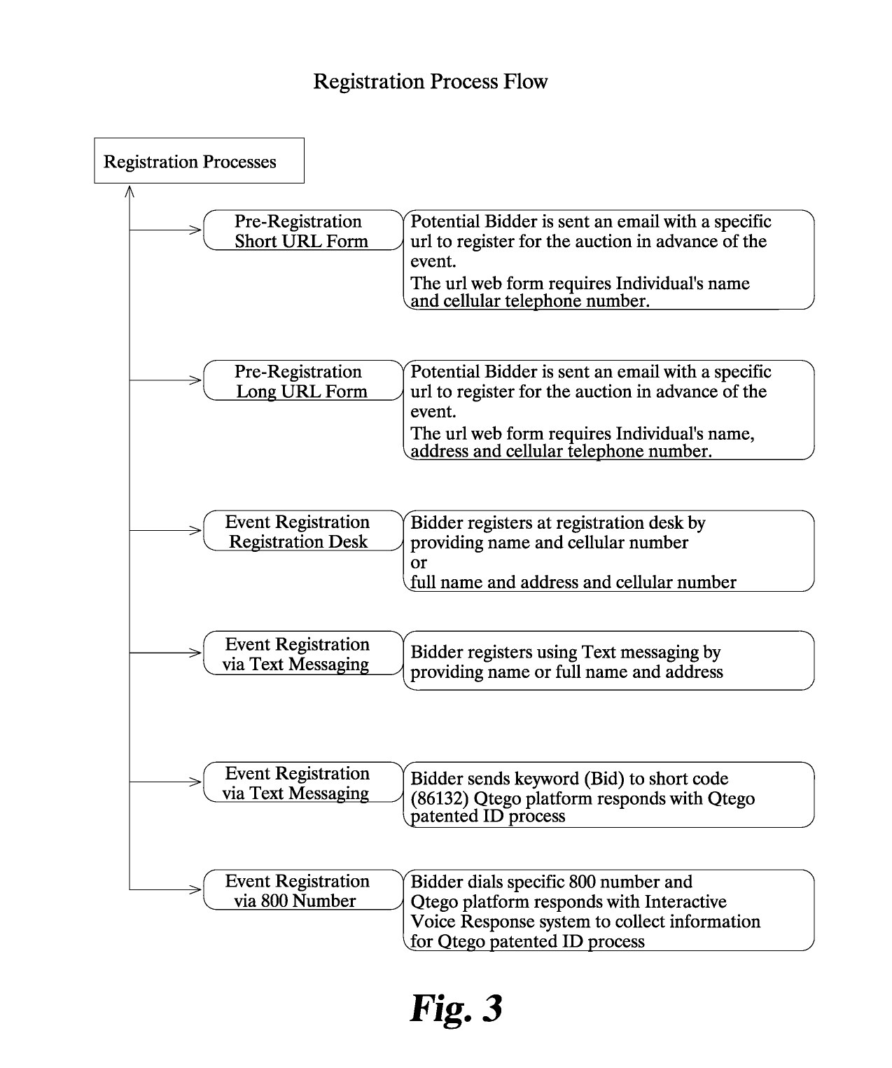

FIG. 3 shows more detail about the bidder registration process. One option for implementing the bidder registration process uses a pre-registration short URL form. An email or text message providing a specific url for the message recipient to use to register for the auction in advance of the event may be sent to prospective bidders. The url web form requires the individual to provide only his/her name and cellular telephone number. Alternatively, the bidder registration process uses a pre-registration long URL form. With this form, an email or text message with a specific url to register for the auction in advance of the event may be sent to prospective bidders. The url web form requires the individual to provide his/her name, address and cellular telephone number.

In another embodiment a prospective bidder may register at an event registration desk. Individuals may register at a registration desk by providing their name and cellular number, or by providing the name, address and cellular number.

In another embodiment a prospective bidder may register for the auction using event registration via text messaging. Individuals may register by sending a text message with their name and/or address and/or phone number. Alternatively, the person may send a keyword to a short code (86132), and the auction management software may responds using the Qtego^{SM} patented ID process.

Finally, prospective bidders may register using an 800 Number. The individual dials a specific 800 number and the Qtego^{SM} platform responds with Interactive Voice Response system to collect information for Qtego^{SM} patented ID process.

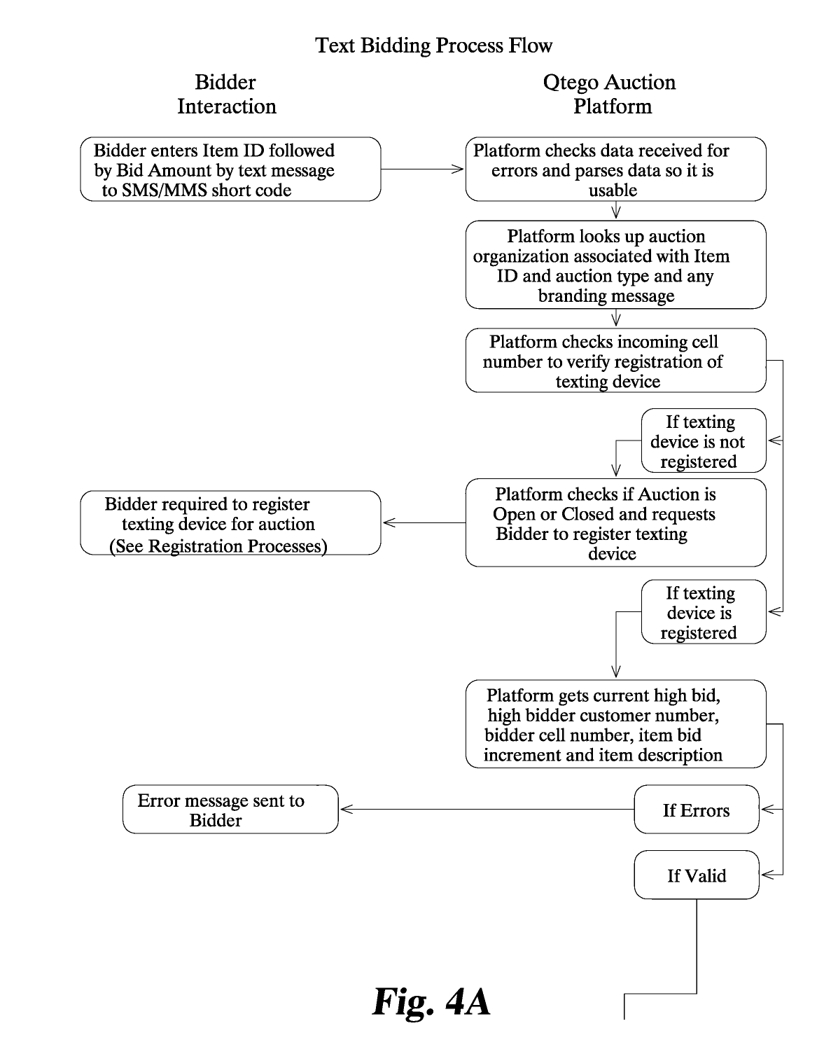

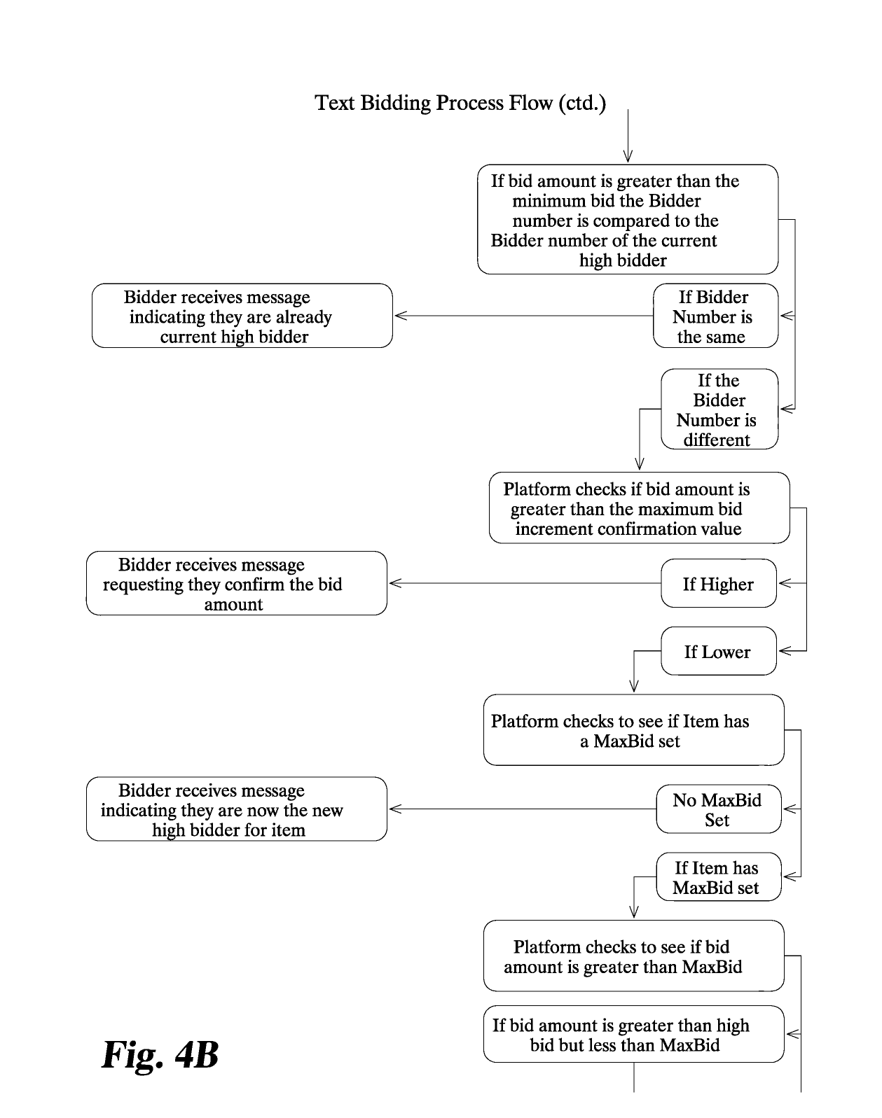

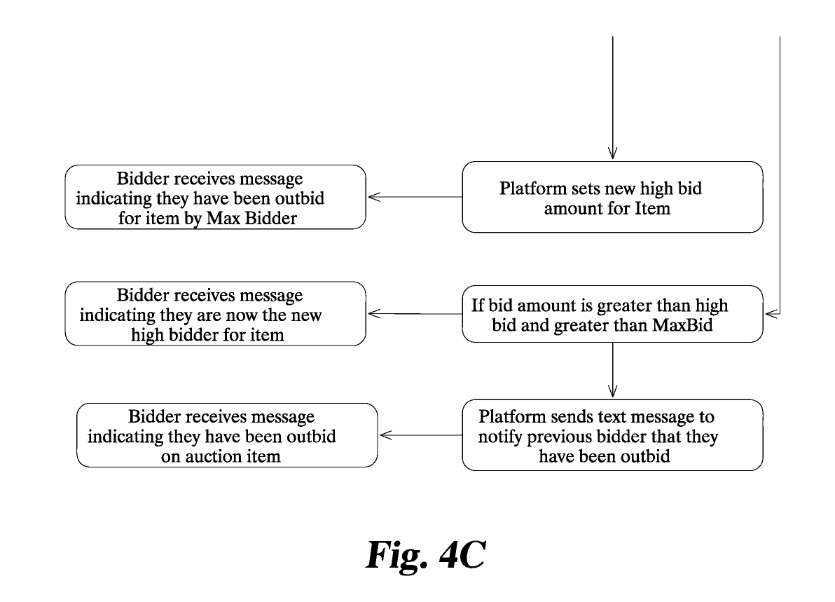

FIGS. 4A, 4B, and 4C show more detail about one embodiment of the text bidding process. To begin the process for the illustrated embodiment, the bidder enters an item ID followed by a bid amount by text message to the phone number (or short code) provided for the auction. The auction management system platform checks the data received for errors and parses data so it is usable. The platform then looks up the auction organization associated with Item ID and auction type and any branding message. The platform then checks incoming cell number to verify registration of texting device.

If the texting device is not registered, the bidder is required to register texting device for auction. The platform then checks to see if the auction is open or closed, and requests the bidder to register his/her device.

If the texting device is registered, the platform retrieves the current high bid, high bidder customer number, the bidder's cell number, item bid increment and item description. If there are errors, an error message is sent to the bidder. If there are no errors (the information is valid), the bid amount is compared to the high bid amount for that item. If the bid amount is greater than the minimum bid the bidder number is compared to the bidder number of the current high bidder. If the bidder number is the same, the bidder receives message indicating they are already current high bidder. If the bidder number is different, the platform checks to see if bid amount is greater than the maximum bid increment confirmation value. If higher, the bidder receives a message requesting they confirm the bid amount. If lower, the platform checks to see if the item has a MaxBid set. If no MaxBid is set, the bidder receives a message indicating they are now the new high bidder for item. If the item has a MaxBid set, the platform checks to see if bid amount is greater than MaxBid. If the bid amount is greater than the high bid but less than MaxBid, the platform sets a new high bid amount for the item and the bidder receives a message indicating they have been outbid for items by Max Bidder. If the amount is greater than the high bid and greater than the MaxBid, the bidder receives a message indicating they are now the new high bidder for the item. The platform also sends a text message to notify the previous bidder that they have been outbid, and that bidder receives a message indicating they have been outbid on the auction item.

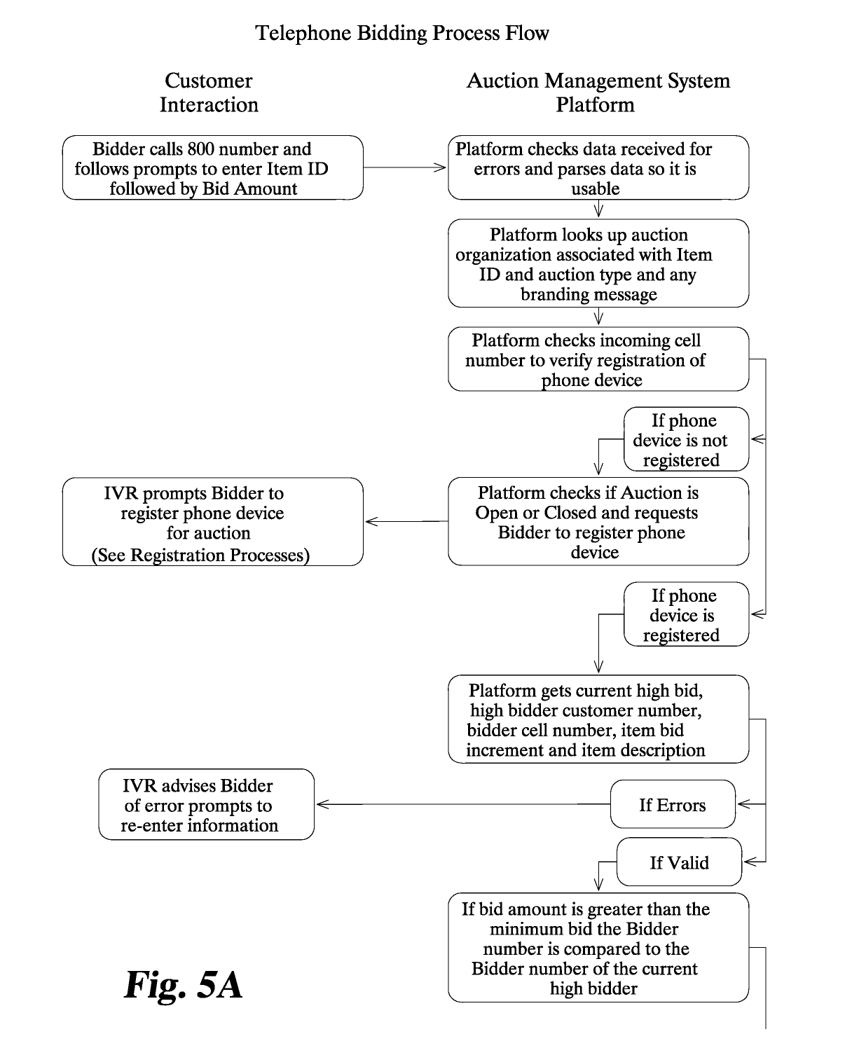

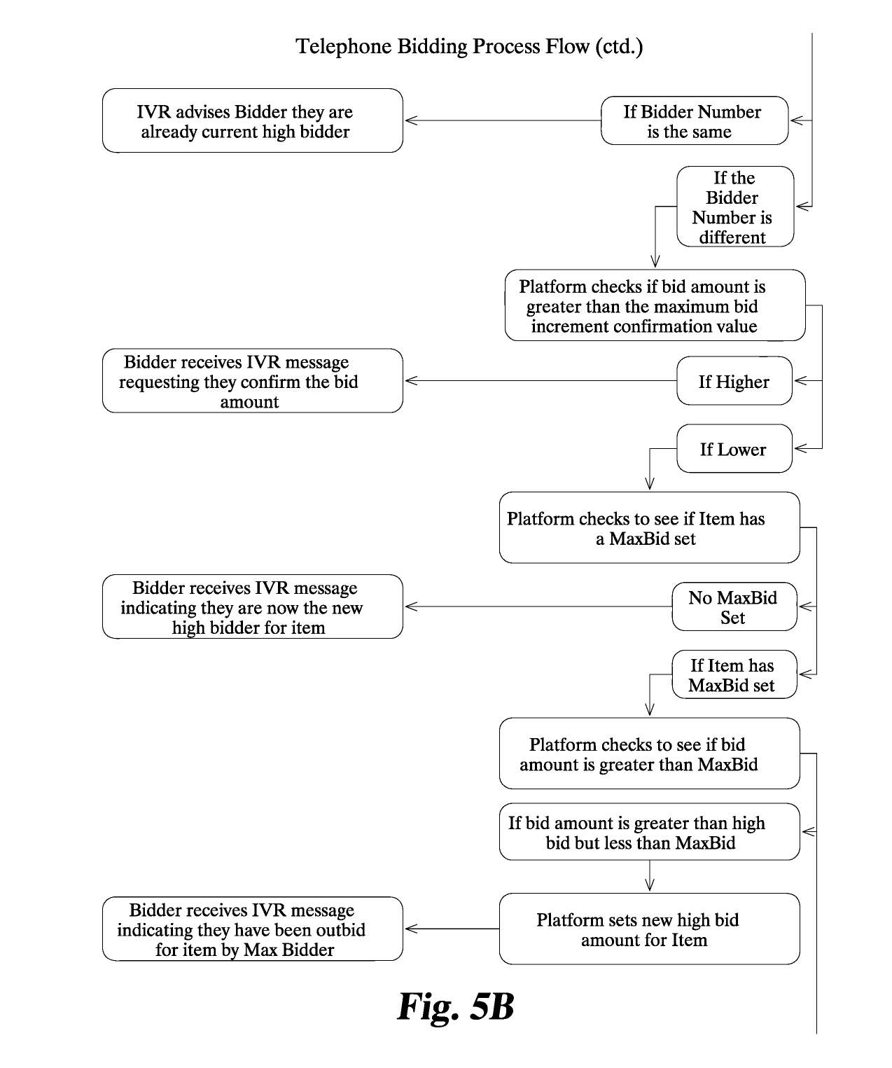

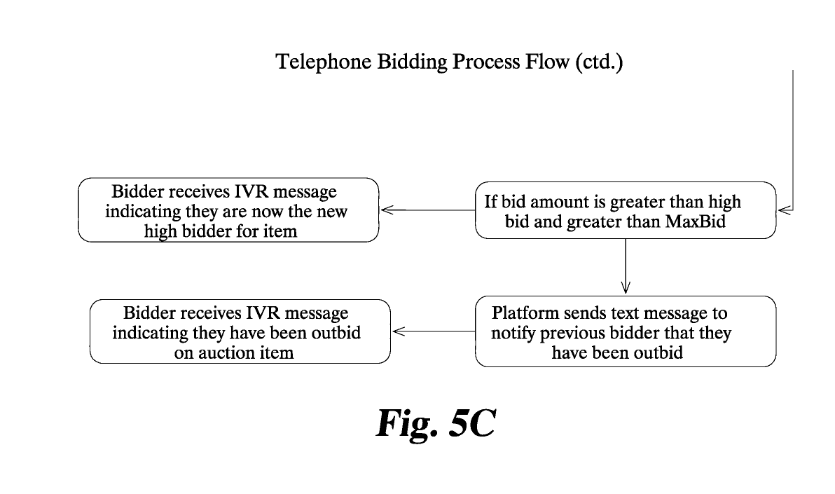

FIGS. 5A, 5B, and 5C show more detail about one embodiment of the telephone bidding process. In the illustrated embodiment, the steps proceed as outlined in the Figure, with the bidding proceeding by telephone rather than by text messaging.

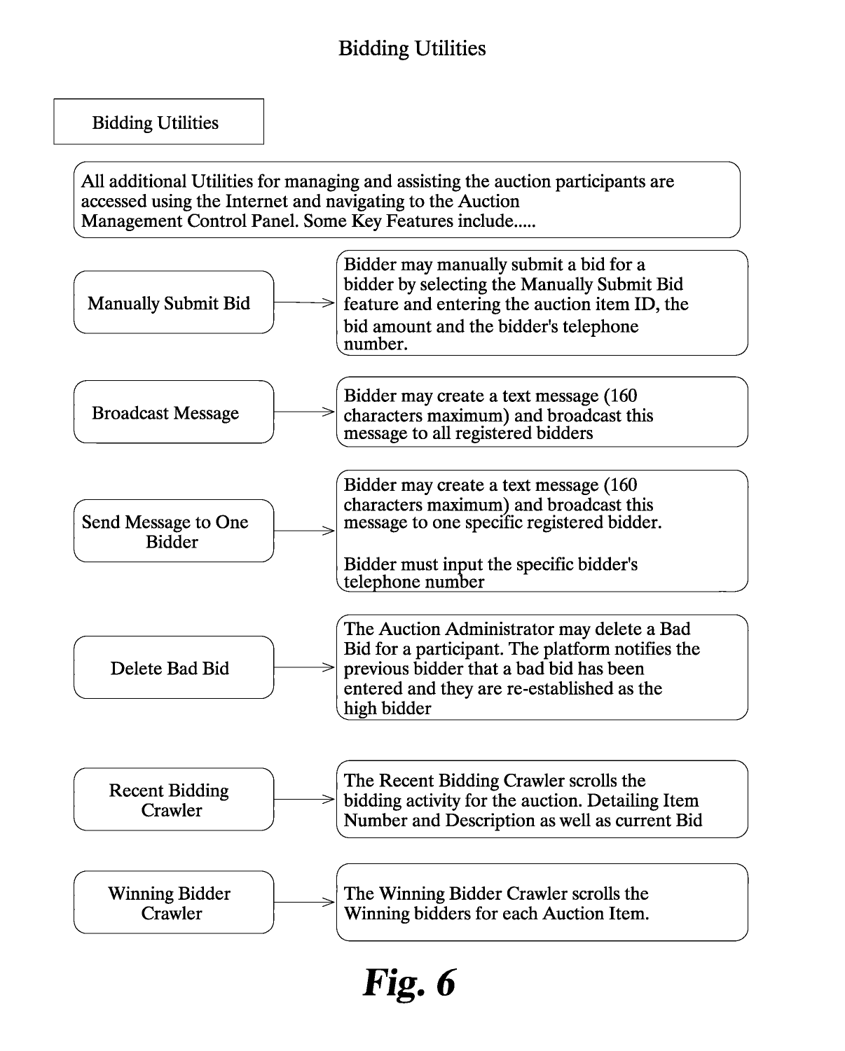

FIG. 6 shows more detail about certain embodiments of the various bidding utilities. All utilities for managing and assisting the auction participants may be accessed using the Internet and navigating to the Qtego^{SM} Account Management Control Panel.

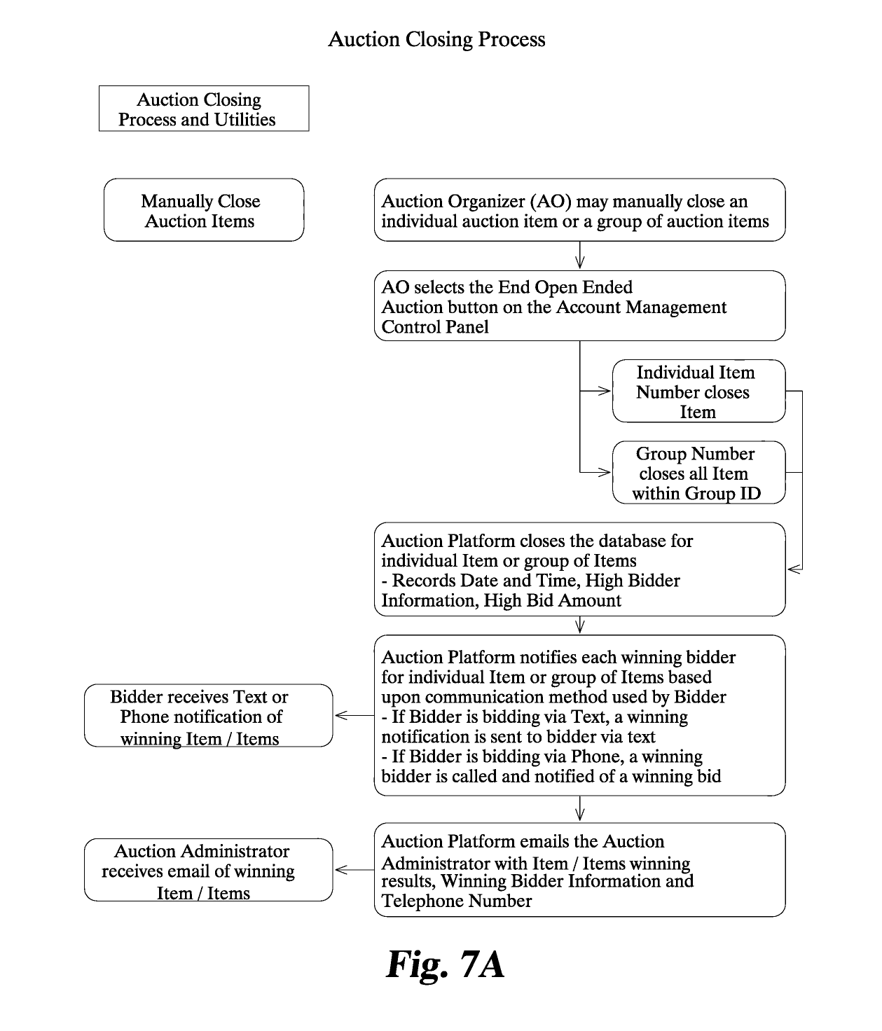

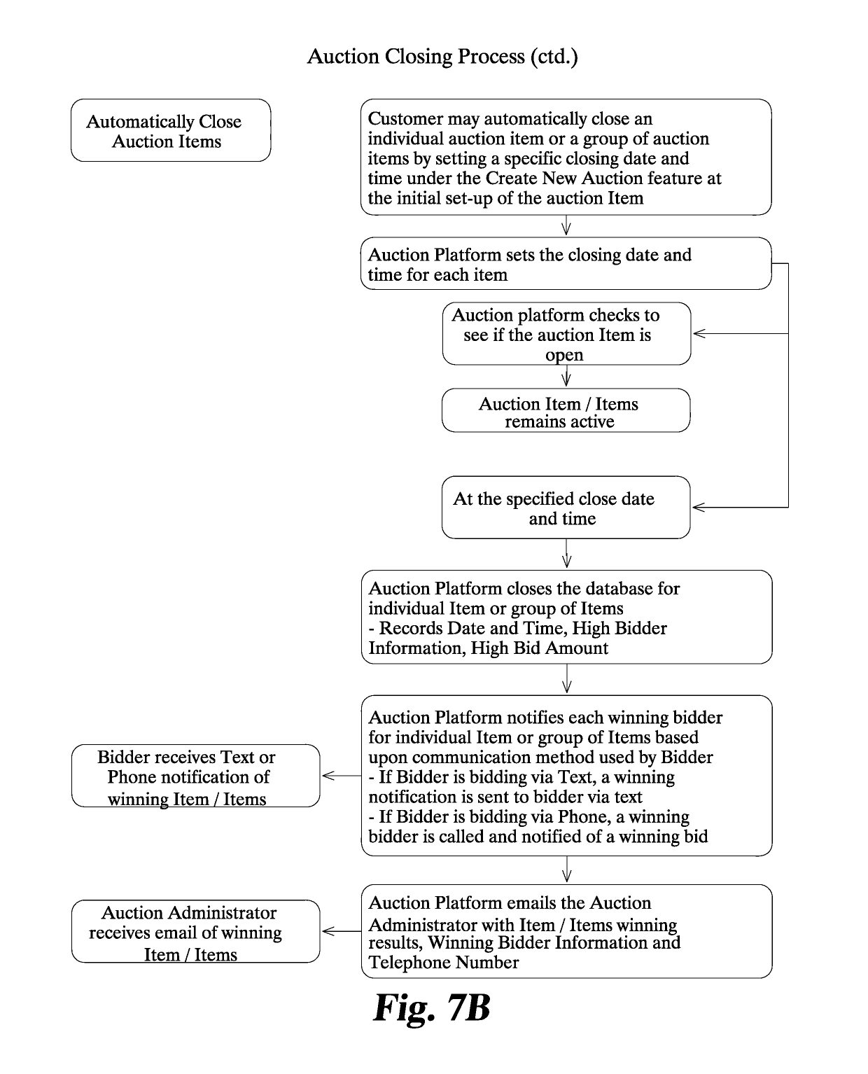

FIGS. 7A and 7B show more detail about certain embodiments of the auction closing process. In the illustrated process, the auction organizer may manually close an individual auction item or a group of auction items. If the auction organizer selects the End Open Ended Auction button on the Account Management Control Panel, an individual item number may be used to close an individual item, or a group number may be used to close all items within a Group ID. The auction platform then closes the database for the individual item or the group of Items. The platform also records the date and time, high bidder information, and high bid amount.

The auction platform notifies each winning bidder for an individual item or group of items based upon communication method used by the bidder. If the bidder is bidding via text messaging, a winning notification is sent to bidder via text. The bidder then receives the text notification of his/her winning item or items. The auction platform also sends an email or text message to the auction administrator with the winning bidder information and telephone number.

Alternatively, the system may be set to automatically close one or more auction items. In particular, the auction organizer may automatically close an individual auction item or group of auction items by setting a specific closing date and time under the Create New Auction feature at the initial set-up of the auction Item. The auction platform then sets the closing date and time for each item. The auction platform checks to see if the auction item is open, and open auction items remain active. At a specified close date and time, the auction platform closes the database for individual Item or group of Items, and records the date and time, high bidder information, and high bid amount. The auction Platform notifies each winning bidder for an individual item or group of items based upon communication method used by the bidder. If the bidder is bidding via text, a winning notification is sent to bidder via text. The bidder then receives a text notification of his/her winning item or items.

The auction platform also sends an email or text message to the auction administrator with the winning results, including the winning bidder information and telephone number. The auction administrator receives the message indicating the winning item information.

It is to be appreciated that when this disclosure refers to a bidder's “personal” of “pre-existing” mobile phone device and/or mobile/wireless service provider, it is intended to mean a device that is normally owned and/or controlled and/or used by the bidder and is not owned or provided by the auction event or the auction event organizer. The specifics of the ownership of the device and the client of the service provider are not important to the extent the device and wireless service carrier are not provided by the auction event or organizer. Accordingly, the device and service may be provided by the bidder, the bidder's employer, the bidder's family, or others without limitation. A local wireless network may be used to provide access to the bidder's wireless service provider.

While the invention has been illustrated and described in detail in the drawings and foregoing description, the same are to be considered illustrative and not restrictive in character, it being understood that only certain preferred embodiments have been shown and described, and that all changes and modifications that come within the spirit of the invention are desired to be protected.

1. A method for conducting a silent auction, comprising:
a) providing auction management software effective for receiving and decoding text messages sent by bidders from the bidders' mobile phone handsets;
b) setting up an auction event by populating said auction management software with information relating to items to be auctioned;
c) registering potential bidders to participate in the auction event, wherein said registering includes associating a potential bidder's personal mobile phone device with said auction event; and
d) allowing registered bidders to bid on items available at the auction event by sending a text message to the auction management software, wherein said sending comprises sending the text message from the bidder's registered personal mobile phone handset using the bidder's personal mobile phone service provider; and
e) decoding the received text message with the auction management software to determine the bidder's identity and the amount of the bidder's bid.

2. The method of claim 1 wherein said auction management system is adapted to manage multiple auctions simultaneously.

3. The method of claim 1 wherein said text message(s) comprise SMS message(s).

4. The method of claim 1 and further including the steps of:
f) having the auction management software communicate back to the bidders to inform the bidders of the status of the bid; and
g) closing the auction by ceasing to allow new bids, identifying the high bidder for items receiving bids, and notifying winners of their successful bids.

5. The method of claim 1 wherein said auction management software is effective for organizing the separate auctions by maintaining for each auction records relating to auction items; wherein said auction records include one or more of:
a) item descriptions;
b) unique item identifications;
c) starting bids;
d) bidding increments;
e) auction start time; and
f) auction end time.

6. The method of claim 1 wherein said “setting up” step comprises populating said auction management software with one or more of:
a) item descriptions;
b) unique item identifications;
c) starting bids;
d) bidding increments;
e) auction start time; and
f) auction end time.

7. The method of claim 1 wherein the method further comprises allowing the bidder to take action subsequent to bidding, wherein said subsequent action comprises entering a second bid on an item for which the bidder is not the high bidder.

8. A system for conducting a silent auction, comprising auction management software effective for receiving bids in the form of text messages from bidders' personal mobile phone handsets using the bidders' personal mobile phone service providers.

9. A system according to claim 8 wherein said system includes auction management software effective for managing multiple auctions simultaneously.
